(19) United States
(12) Patent Application Publication
(10) Pub. No.: US 2019/0064196 A1
(43) Pub. Date: Feb. 28, 2019

(54) SYRINGE PUMP BASED PRODUCED FLUID COLLECTION SYSTEM

(71) Applicant: The Saskatchewan Research Council, Saskatoon (CA)

(72) Inventors: Farrell David Kemp BAIRD, Pilot Butte (CA); Bart SCHNELL, Regina (CA); Ray EXELBY, Craven (CA)

(21) Appl. No.: 16/111,899

(22) Filed: Aug. 24, 2018

Related U.S. Application Data
(60) Provisional application No. 62/550,282, filed on Aug. 25, 2017.

(51) Int. Cl. G01N 35/10; G01N 15/08; G01N 35/08

(52) U.S. Cl. CPC G01N 35/1095; G01N 15/0826; G01N 2035/1025; G01N 35/1016; G01N 35/085

(57) ABSTRACT

A system and method for collecting produced fluid from a laboratory test chamber using a plurality of syringe pumps, wherein the pressure is selectively controlled during the collecting, and the pressure is selectively reduced prior to expelling the produced fluid to one or more collection flasks.

### CROSS REFERENCE TO RELATED APPLICATIONS

This application claims priority to U.S. Provisional Application 62/550,282 filed Aug. 25, 2017, the contents of which is incorporated herein by reference in its entirety.

### FIELD

The present disclosure relates generally to testing apparatus. More particularly, the present disclosure relates to collecting fluids from a testing apparatus.

### BACKGROUND

In the laboratory testing of physical research models, such as coreflood systems or other physical petroleum models, the results may be susceptible to pressure fluctuations. Erratic production pressure causes unstable differential pressures (DP) through the simulated reservoir matrix. These fluctuations in DP are not present in the field as there are different conditions at play. Typically, in the field the bottom hole pressure is a result of the hydrostatic column height and pumps are used to draw the fluid out of the hole and bring the fluids to surface.

However, in laboratory scale tests, one wants to simulate the pressures that the matrix and oil experience in the reservoir, but eventually the fluids must be produced to ambient pressures. The process of controlling the pressure drop from an elevated system pressure to ambient is important due to the susceptibility of the models to erratic pressure fluctuations.

One may use a back pressure regulator (BPR), an adjustable valve, or a computer controlled flow control valve (FCV). However, one drawback of BPRs is that pressure regulation may be erratic when the fluid is a heterogeneous mixture of fluids having vastly different viscosities, such as oil or heavy oil and water. One drawback of FCVs is that they tend to be on PID (proportional-integral-derivative) or PI (proportional-integral) control and it can be difficult to set appropriate gains for the P (proportional) and I (integral) control system that provide sufficiently stable pressure and responsiveness for multiphase fluids, for example water, gas, and oil.

It is, therefore, desirable to provide an improved pressure controlled fluid collection system.

### SUMMARY

It is an object of the present disclosure to obviate or mitigate at least one disadvantage of previous fluid collection systems.

The present disclosure provides a system and method for collecting fluids at pressure, reducing the pressure, and measuring one or more properties of the fluids.

In an first aspect, the present disclosure provides a method collecting a produced fluid, including:

a. selectively receiving the produced fluid with a first syringe pump;

b. selectively receiving the produced fluid with a second syringe pump once the first syringe pump reaches a first sample volume;

c. expelling the produced fluid from the first syringe pump to a collection flask while receiving the produced fluid with the second syringe pump;

d. selectively receiving the produced fluid with the first syringe pump once the second syringe pump reaches a second sample volume; and

e. expelling the produced fluid from the second syringe pump to the collection flask while receiving the produced fluid with the first syringe pump.

In an embodiment disclosed, b. through e. are repeated one or more times.

In an embodiment disclosed, the method further includes maintaining a selected pressure in the first syringe pump, the second syringe pump, or both.

In an embodiment disclosed, the method further includes maintaining a selected pressure in the first syringe pump or the second syringe pump, as the case may be, while receiving the produced fluid.

In an embodiment disclosed, a produced volume of the produced fluid is held constant while there is a drop in a system pressure.

In an embodiment disclosed, the method further includes reducing the selected pressure to an expel pressure prior to expelling the produced fluid from the first syringe pump or the second syringe pump, as the case may be. In an embodiment disclosed, the expel pressure is substantially zero psig/kPag.

In an embodiment disclosed, the collection flask comprises a plurality of collection flasks, the method further including selectively expelling the produced fluid to one of the plurality of collection flasks.

In an embodiment disclosed, the one of the plurality of collection flasks is incremented before each expelling.

In an embodiment disclosed, the produced fluid in each of the plurality of collection flasks is analyzed separately.

In an embodiment disclosed, the produced fluid is collected from a test chamber.

In an embodiment disclosed, the produced fluid includes oil and water. In an embodiment disclosed, the produced fluid is substantially oil and water.

In an embodiment disclosed, the produced fluid includes condensate substantially at its saturated liquid state. In an embodiment disclosed, the produced fluid is substantially condensate substantially at its saturated liquid state.

In an embodiment disclosed, the produced fluid includes multiphase fluid. In an embodiment disclosed, the produced fluid is substantially multiphase fluid.

In an embodiment disclosed, the multiphase fluid includes water, gas, and oil. In an embodiment disclosed, the multiphase fluid is substantially water, gas, and oil.

In an embodiment disclosed, the method includes analyzing the produced fluid to provide a produced fluid analysis.

In an embodiment disclosed, the produced fluid analysis comprises fractional flow data analysis.

In a further aspect, the present disclosure provides a computer readable medium having thereon computer instruction code which may be interpreted by a computer to perform the method of the present disclosure or portions thereof.

In a further aspect, the present disclosure provides a system for collecting a produced fluid including:

a. a first syringe pump;

b. a second syringe pump; and

c. a controller, adapted to selectively direct the produced fluid to the first syringe pump or the second syringe pump, the controller further adapted to selectively expel the produced fluid from the other of the first syringe pump and the second syringe pump.

In an embodiment disclosed, the controller is adapted to selectively actuate one or more control means to selectively direct the produced fluid.

In an embodiment disclosed, the one or more control means includes one or more control valves.

In an embodiment disclosed, the controller is adapted to control a selected pressure in the first syringe pump or the second, as the case may be, as the produced fluid is directed to the first syringe pump or the second syringe pump.

In an embodiment disclosed, a produced volume of the produced fluid is held constant while there is a drop in a system pressure.

In an embodiment disclosed, the controller is adapted to reduce the selected pressure to an expel pressure prior to expelling the produced fluid from the first syringe pump or the second syringe pump, as the case may be. In an embodiment disclosed, the expel pressure is substantially zero psig/kPag.

In an embodiment disclosed, the system further includes a multiport production system adapted to selectively direct the expelled produced fluid to one of a plurality of collection flasks.

In an embodiment disclosed, the multiport production system includes a multiport valve, having an inlet and a plurality of outlets, each configured to discharge to a corresponding one of the plurality of collection flasks.

In an embodiment disclosed, the controller is adapted to selectively increment the multiport valve corresponding to the selectively expelling the produced fluid.

Other aspects and features of the present disclosure will become apparent to those ordinarily skilled in the art upon review of the following description of specific embodiments in conjunction with the accompanying figures.

### BRIEF DESCRIPTION OF THE DRAWINGS

Embodiments of the present disclosure will now be described, by way of example only, with reference to the attached Figures.

FIG. 1 is a system of the present disclosure.

FIG. 2 is the system of FIG. 1, in operation.

FIG. 3 is the system of FIG. 1, in operation.

FIG. 4 is the system of FIG. 1, in operation.

FIG. 5 is the system of FIG. 1, in operation.

### DETAILED DESCRIPTION

Generally, the present disclosure provides a method and system for controlled fluid collection.

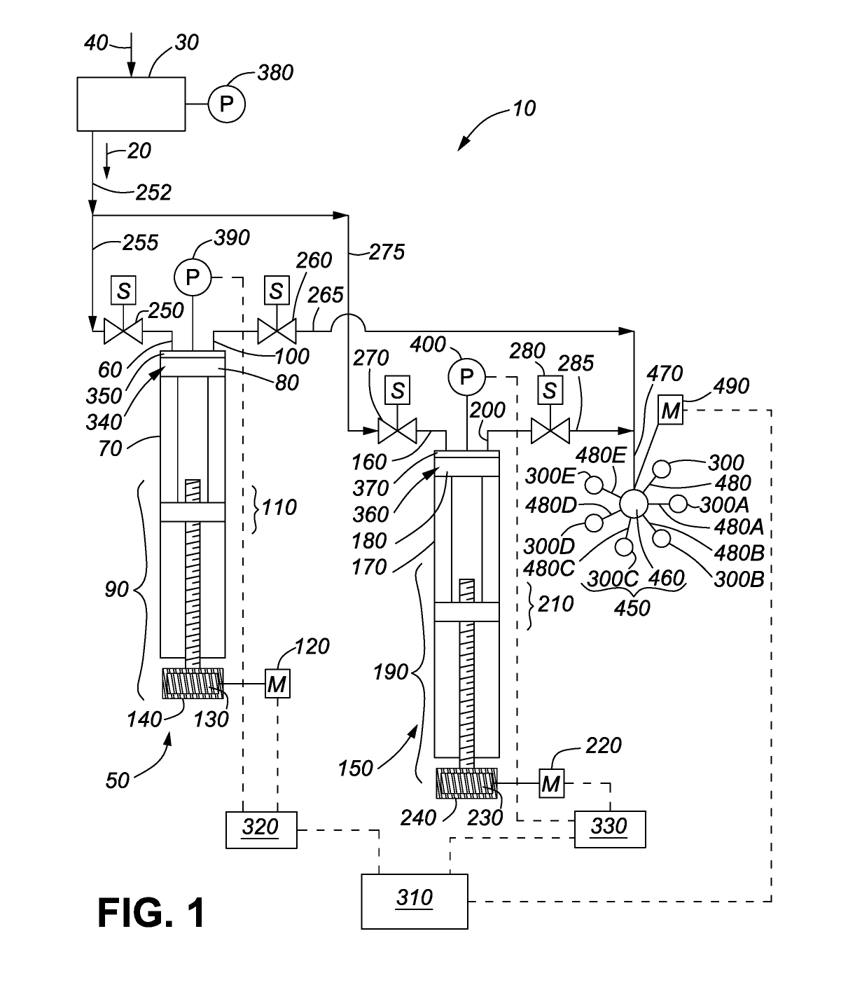

Referring to FIG. 1, a system 10 of the present disclosure is used to collect a produced fluid 20 from a test chamber 30. In an embodiment disclosed, the test chamber 30 is a petroleum research model, for example a reservoir physical model representing a simulated reservoir matrix (e.g. a core or oil filled/packed sand or rock) into which steam or other fluid may be provided via inlet 40. The fluid may be supplied by an injection pump or pressure differential between a fluid supply and the test chamber 30.

The produced fluid 20 may be selectively directed to one of a plurality of syringe pumps. Referring to FIG. 1, a first syringe pump 50 has a first inlet 60, a first cylinder 70, a first piston 80 in the first cylinder 70, a first piston drive 90, and a first outlet 100. The first piston drive 90 may include a first rotary to linear converter 110 which is driven by a first motor 120 through a gear system (first worm gear 130 and first pinion 140 shown).

A second syringe pump 150 has a second inlet 160, a second cylinder 170, a second piston 180 in the second cylinder 170, a second piston drive 190, and a second outlet 200. The second piston drive 190 may include a second rotary to linear converter 210 which is driven by a second motor 220 through a gear system (second worm gear 230 and second pinion 240 shown).

A plurality of control valves in respective flow lines are used to control the flow of the produced fluid 20 in conjunction with operation of the first syringe pump 50 and the second syringe pump 150. In the simplified schematic of FIG. 1, a first inlet control valve 250 in a first inlet flow line 255, a first outlet control valve 260 in a first outlet flow line 265, a second inlet control valve 270 in a second inlet flow line 275, and a second outlet control valve 280 in a second outlet flow line 285 are shown. While shown as solenoid valves for simplicity, the control valves may utilize any type of actuator, including but not limited to motor controlled, pneumatic, hydraulic, solenoid, or otherwise and may utilize any type of operation, including analog, digital, fibre-optic, mixed-mode or otherwise. In an embodiment disclosed, the control valves are on/off valves.

The produced fluid 20 is collected in one or more collection flasks 300, 300A, 300B, 300C, 300D, 300E as described below. In an embodiment disclosed, a sample size is selectable. In an embodiment disclosed, the sample size is independent of the size of the test chamber 30 and/or the size/number of collection flasks 300.

In an embodiment disclosed, a computer 310, for example a programmable logic controller or other controller or a general purpose computer is used to control the first syringe pump 50, the second syringe pump 150, the first inlet control valve 250, the first outlet control valve 260, the second inlet control valve 270, and the second outlet control valve 280. However, like the actuator 490 (see below) these components are operably connected with the computer 310. Similarly, while not shown, first pump pressure 390 and second pump pressure 400 may also be operatively connected to the computer 310, for example to monitor and/or record the pressures. In an embodiment disclosed, the first syringe pump 50 is operated by a first pump controller 320, the second syringe pump 150 is operated by a second pump controller 330, and the first pump controller 320, the second pump controller 330, the first inlet control valve 250, the first outlet control valve 260, the second inlet control valve 270, and the second outlet control valve 280 are controlled by the computer 310. Control may include sending a control signal, sending a control signal and receiving a feedback signal and/or receiving a measurement. The computer 310 may utilize systems engineering software for data acquisition, control, and automation, such as LabVIEW™ by National Instruments™ programmed in accordance with the present disclosure. In an embodiment disclosed, the computer 310 may be used to directly control the first syringe pump 50 and the second syringe pump 150 without the first pump controller 320 and the second pump controller 330.

In an embodiment disclosed, the produced fluid 20 is collected as follows:

The system 10 is set up with the first piston 80 in a first minimum volume position 340 with a corresponding first minimum volume 350 and the second piston 180 in a second minimum volume position 360 with a corresponding second minimum volume 370 (shown in FIG. 1). The first minimum volume 350 and the second minimum volume 370 are set using the respective pump controller 320, 330 and/or the computer 310. The flow lines 252, 255, 265, 275, 285 and the first minimum volume 350 and the second minimum volume 370 may be purged/filled with an initial fluid. The initial fluid may be, for example, a non-compressible liquid, such as deionized water.

The first inlet control valve 250 is open or opened and therefore a pressure 380 of test chamber 30 and a first pump pressure 390 are substantially equal. The first outlet control valve 260 and the second inlet control valve 270 are closed.

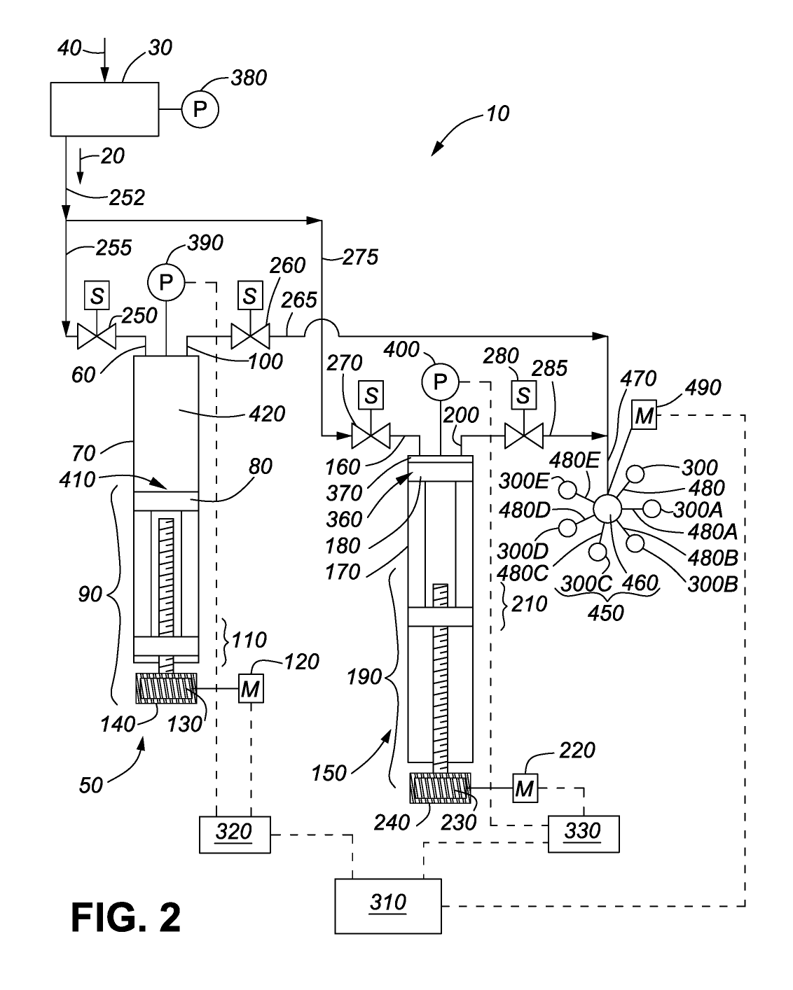

The first pump controller 320 or the computer 310 (as the case may be) is configured to maintain a set backpressure (first pump pressure 390) in the first cylinder 70 of the first syringe pump 50 by backing off the first piston 80 by selectively operating the first motor 120 (in FIG. 1 by moving the first piston 80 downward). This will continue as produced fluid 20 is received in the first cylinder 70 until the first piston 80 reaches a first maximum volume position 410 with a corresponding first maximum volume 420 (see FIG. 2). The first maximum volume 420 is set using the first pump controller 320 or the computer 310 as the case may be. In an embodiment disclosed, a smaller sample may be obtained, that is less than the first maximum volume 420 minus the first minimum volume 350.

The pressure of the produced fluid 20 may vary dynamically and/or transiently, for example if the pressure of the test chamber 30 changes due to pressures or flows within the test chamber or if, for example, a change in fluid conditions/properties results in a change in pressure, such as PVT effects or condensation. As an example, when the produced fluid 20 includes a condensable vapour, such as steam, condensation of the steam to water as the produced fluid 20 cools will dramatically reduce the volume, causing a significant pressure drop.

In an embodiment disclosed, the set backpressure (first pump pressure 390 and second pump pressure 400) is held constant if the pressure of the produced fluid 20 drops below the set backpressure. The syringe pumps work like a back pressure regulator in that they only accept fluid and maintain a maximum system pressure. If the system pressure drops below the setpoint, the pump (controller) does nothing to compensate—i.e. the produced volume is held constant while there is a drop in the system pressure, for example the volume of fluid in the syringe pump is unchanged—e.g. the piston 80/180, as the case may be, is not actuated to maintain system pressure (as doing so in this situation could convey the produced fluid 20 in the syringe pump back into the test chamber 30). This prevents the syringe pump from conveying the produced fluid 20 from the syringe pump back into the test chamber 30 in order to maintain the pressure, which could have adverse effects. Once the produced fluid 20 is received in the first syringe pump 50 or the second syringe pump 150, as the case may be, it is not displaced back into the model (test chamber 30).

Referring to FIG. 2, the produced fluid 20 is seamlessly directed to the second syringe pump 150 by opening the second inlet control valve 270 and closing the first inlet control valve 250 using the computer 310. The second pump pressure 400 is adjusted to substantially match the first pump pressure 390 before the switch. The produced fluid 20 is received in the second syringe pump 150 in the same manner as described above in relation to the first syringe pump 50. As above, the sample collected need not be the maximum volume permitted by the syringe pump, and a smaller sample may be obtained, that is less than the second maximum volume 440 minus the second minimum volume 370.

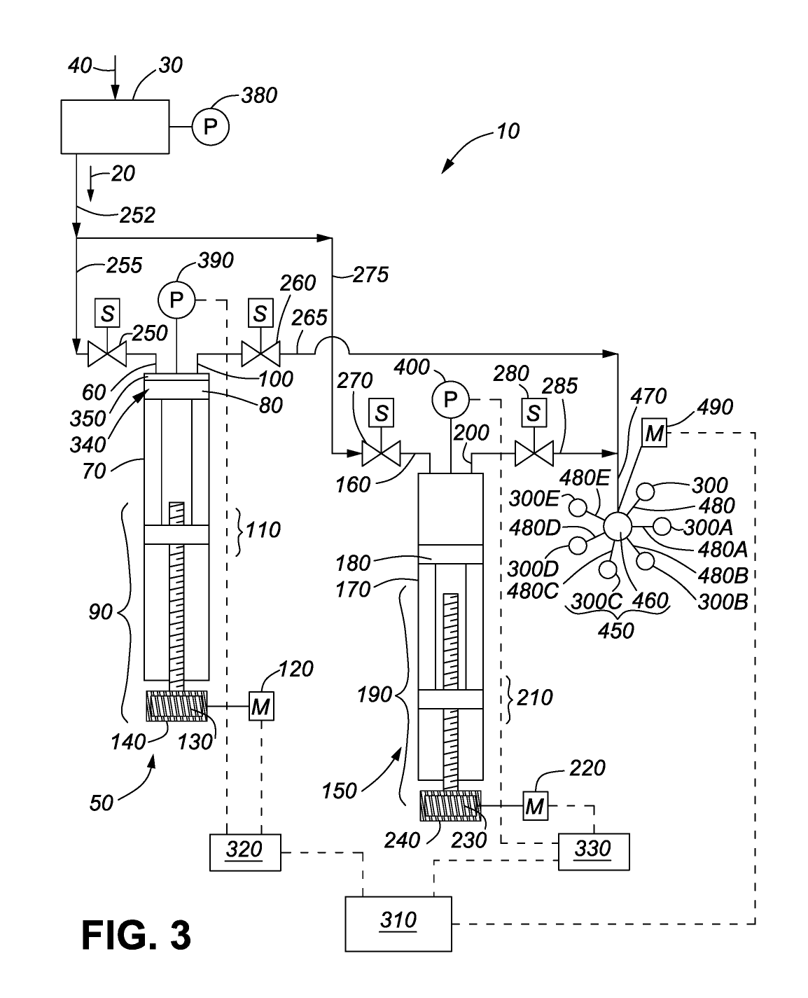

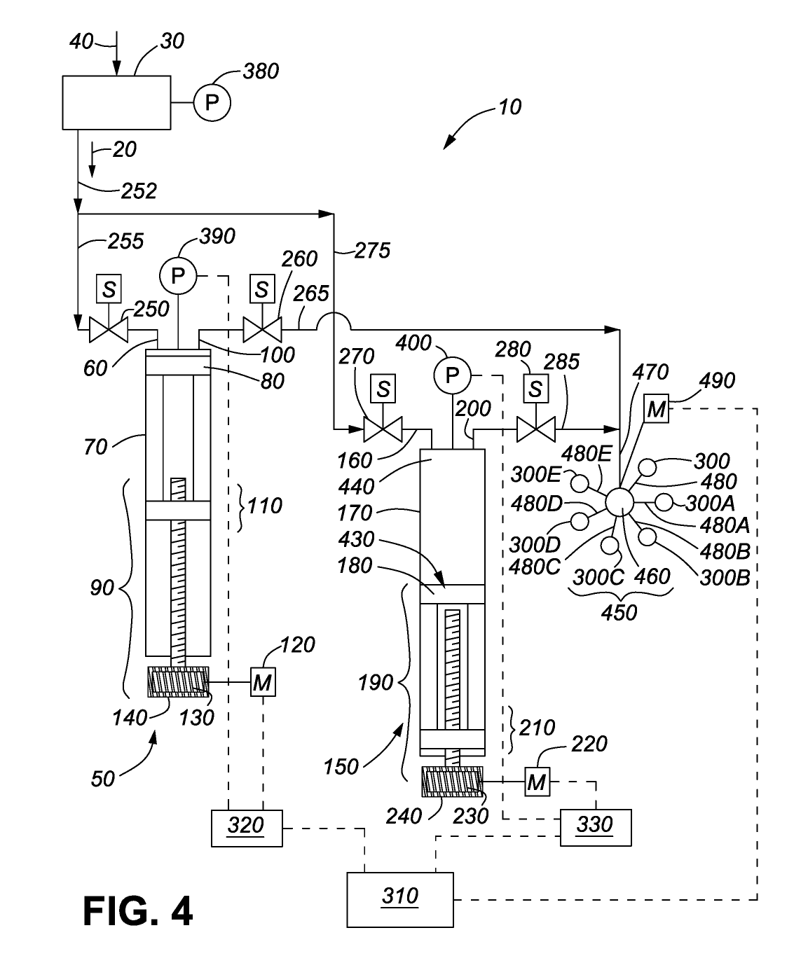

Meanwhile, the produced fluid 20 collected in the first syringe pump 50 is expelled into one of the one or more collection flasks 300-300E. The first pump pressure 390 in the first syringe pump 50 is adjusted to an expel pressure, and the first outlet control valve 260 is opened and the first syringe pump 50 operated by the first pump controller 320 or the computer 310 to drive the first piston 80 from the first maximum volume position 410 to the first minimum volume position 340. In doing so, the first syringe pump 50 may be operated at the expel pressure to provide an expel rate. In an embodiment disclosed, the expel pressure may be a substantially low and safe pressure, such as zero psig/kPag. In an embodiment disclosed, the collected fluid is expelled by displacement, rather than by differential pressure. As the first piston 80 reaches the first minimum volume position 340 (see FIG. 3) the first outlet control valve 260 is closed and the first pump pressure 390 of the first syringe pump 50 adjusted to substantially match the pressure 380 of the test chamber 30. The first syringe pump 50 is thus again ready to receive produced fluid 20 (as it was in FIG. 1). Meanwhile, the produced fluid 20 continues to be received in the second syringe pump 150 until the second piston 180 reaches the second maximum volume position 430 with a corresponding second maximum volume 440 (see FIG. 4). The second maximum volume 440 is set using the second pump controller 330 or the computer 310.

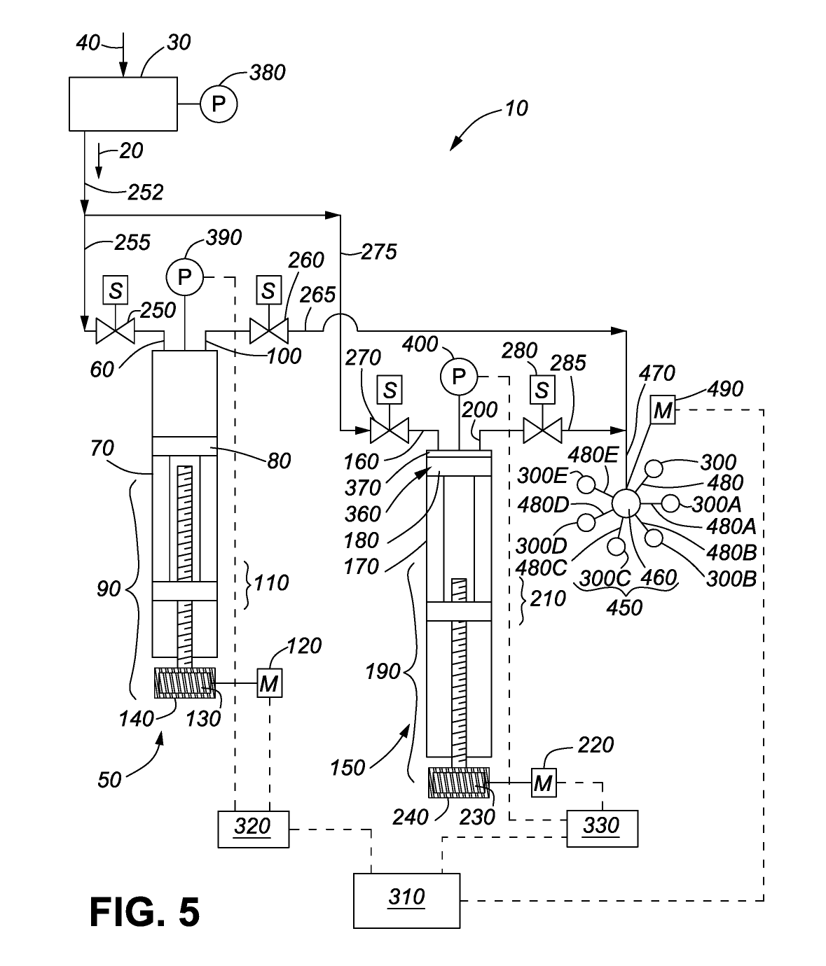

Referring to FIG. 4, the produced fluid 20 is seamlessly directed to the first syringe pump 50 by opening the first inlet control valve 250 and closing the second inlet control valve 270. The first pump pressure 390 is adjusted to match the second pump pressure 400 before the switch. The produced fluid 20 is received in the first syringe pump 50 in the same manner as described above previously. Meanwhile, the produced fluid 20 collected in the second syringe pump 150 is expelled into one of the one or more collection flasks 300-300E in the same manner as described above in relation to the first syringe pump 50. As the second piston 180 reaches the second minimum volume position 360 (see FIG. 5) the second outlet control valve 280 is closed and the second pump pressure 400 of the second syringe pump 150 adjusted to substantially match the pressure 380 of the test chamber 30. The second syringe pump 150 is thus again ready to receive produced fluid 20 (as it was in FIG. 1).

At the conclusion of the test, the produced fluid 20 in the first syringe pump 50 or the second syringe pump 150 (as the case may be) is expelled into one of the one or more collection flasks 300-300E. The flow lines 252, 255, 265, 275, 285 and the first syringe pump 50 and the second syringe pump 150 may be cleaned with a solvent, such as toluene. The toluene and fluid are collected and the quantity of fluid that is not toluene (e.g. oil) included in the amount or analysis with the one or collection flasks 300-300E. Measurement errors in this method are consistent and therefore easily accounted for between tests.

In an embodiment disclosed, the first syringe pump 50, the second syringe pump 150, and if necessary additional syringe pumps are sized such that at least one syringe pump is available at all times to receive the produced fluid 20 from the test chamber 30. In the case of two syringe pumps (the first syringe pump 50 and the second syringe pump 150) as in FIGS. 1-5, that simply means that once a pump reaches its maximum volume, the produced fluid 20 must be expelled to one of the one or more collection flasks 300-300E, and the pump returned to its minimum volume ready to receive the produced fluid 20 before the other pump reaches its maximum volume. This allows continuous operation. A first pump capacity of the first syringe pump 50 is equal to the first maximum volume 420 minus the first minimum volume 350. The second pump capacity of the second syringe pump 150 is equal to the second maximum volume 440 minus the second minimum volume 370. Each of the one or more collection flasks 300-300E must have a volume sufficient to hold the contents of one syringe pump (or if they are of different sizes, the largest syringe pump), i.e. at least the greater of the first pump capacity and the second pump capacity to hold the produced fluid 20 expelled from the respective syringe pump.

In an embodiment disclosed, the produced fluid 20 is a multiphase fluid, for example containing a plurality of liquids or a plurality of gases or both, for example water, gas, and oil. The produced fluid 20 may be a multiphase fluid at the conditions (e.g. pressure and temperature) of the test chamber 30, for example at the test chamber outlet line 252. The quantity of the produced fluid 20 may be measured by a flow meter and the composition analyzed, for example by gas chromatography. Some constituents of the produced fluid 20 may only exist as liquids under the conditions inside the test chamber 30. Such constituents will flash to gasses or vapours when the produced fluids 20 are depressurized, for example in the first syringe pump 50 and the second syringe pump 150 when the pressure is reduced. The quantity or the composition of the produced fluids, or both, may be measured/analyzed at one or more locations between the test chamber 30 and the collection flask 300. Suitable locations include the test chamber outlet flow line 252, the first inlet flow line 255, the second inlet flow line 275, the first outlet flow line 265, the second outlet flow line 285, and the inlet 470 to the multiport production system 450. In an embodiment disclosed, the produced fluid 20 includes water, liquid hydrocarbons, gaseous hydrocarbons, or mixtures thereof. In an embodiment disclosed, the produced fluid 20 is an emulsion. In an embodiment disclosed, the produced fluid 20 is a heterogeneous mixture of fluids with significantly different viscosities. In an embodiment disclosed, the produced fluid 20 includes water or hydrocarbons at or near pressure and temperature conditions on its saturation curve. Such fluids tend to readily condense/flash as the pressure is increased/decreased. In an embodiment disclosed the produced fluid 20 includes saturated water or saturated water having a sub-cool of less than 10 degrees Celsius.

In an embodiment disclosed a multiport production system (MPPS) 450, operable by the computer 310, automatically directs the produced fluid 20 expelled from the first production pump 50 or the second production pump 150 (as the case may be) to one of the one or more collection flasks 300-300E. A multiport valve 460 having one inlet 470 and two or more outlets (six outlets 480-480E shown, each configured to discharge to the corresponding collection flasks 300-300E) is incremented one position after each of the first syringe pump 50 or the second syringe pump 150 is emptied, by an actuator 490. That is, for example, if the multiport valve 460 is initially set to direct the flow to the outlet 480 and thus the collection flask 300, the contents of the first syringe pump 50 are expelled to the collection flask 300. Once that is complete, e.g. the first piston 80 reaches the first minimum volume position 340, the multiport valve 460 is incremented to the next position, i.e. outlet 480A to discharge to the collection flask 300A. When the contents of the second syringe pump 150 are expelled, they are thus directed to the collection flask 300A. Once complete, the multiport valve 460 is again incremented, now to outlet 480B to discharge to the collection flask 300B and so on. Alternatively, the one or more collection flasks 300-300E may be manually changed, for example by the user. While shown the actuator 490 is shown as an electrically operated motor controlled valve for simplicity, the multiport valve 460 may utilize any type of actuator 490, including but not limited to motor controlled, pneumatic, hydraulic, solenoid, or otherwise and may utilize any type of operation, including analog, digital, fibre-optic, mixed-mode or otherwise.

The one or more collection flasks 300-300E may be combined to provide a bulk overall analysis of the produced fluid 20 or they may be individually analyzed to yield additional information, such as how the flow rate or composition of the produced fluid varies over time which can be an important factor in oil or gas production, for example oil fraction or water fraction. The collected one or more collection flasks 300-300E provide insight into the produced fluid 20. One aspect is to obtain fractional flow data from each of the one or more collection flasks 300-300E, which are the fractions of the total produced fluids which are typically oil, water, and gas.

In an embodiment disclosed, the one or more collection flasks 300-300E may be open to atmosphere. Thus, as the produced fluid 20 is depressurized in the respective first syringe pump 50 or second syringe pump 150, a portion of the produced fluid 20 may flash/evaporate from liquid to vapour. As mentioned above, the gas component may be measured or analyzed or both in one or more of the first outlet flow line 265, second outlet flow line 285, or inlet 470. In an alternate embodiment, a closed system (not open to atmosphere) is provided, such that vapours cannot escape, and thus can be collected to be quantified or analyzed or both.

The system 10 utilizes off the shelf components along with custom control commands which provide instructions to the syringe pump controllers 320,330 or directly to the first syringe pump 50 and the second syringe pump 150 to implement the disclosed invention. In an embodiment disclosed, the control commands may be implemented by the computer 310, for example by a program in LabVIEW (see above).

In the preceding description, for purposes of explanation, numerous details are set forth in order to provide a thorough understanding of the embodiments. However, it will be apparent to one skilled in the art that these specific details are not required. In other instances, well-known structures and components are shown in simplified or block diagram form in order not to obscure the understanding. For example, specific details are not provided as to whether the embodiments described herein are implemented as a software routine, hardware circuit, firmware, or a combination thereof.

Embodiments of the disclosure can be represented as a computer program product stored in a machine-readable medium (also referred to as a computer-readable medium, a processor-readable medium, or a computer usable medium having a computer-readable program code embodied therein). The machine-readable medium can be any suitable tangible, non-transitory medium, including magnetic, optical, or electrical storage medium including a diskette, compact disk read only memory (CD-ROM), memory device (volatile or non-volatile), or similar storage mechanism. The machine-readable medium can contain various sets of instructions, code sequences, configuration information, or other data, which, when executed, cause a processor to perform steps in a method according to an embodiment of the disclosure. Those of ordinary skill in the art will appreciate that other instructions and operations necessary to implement the described implementations can also be stored on the machine-readable medium. The instructions stored on the machine-readable medium can be executed by a processor or other suitable processing device, and can interface with circuitry to perform the described tasks.

Embodiments may include but are not limited to any combination of the methods, systems and apparatus described herein and in the following paragraphs.

A method collecting a produced fluid, comprising selectively receiving the produced fluid with a first syringe pump, selectively receiving the produced fluid with a second syringe pump once the first syringe pump reaches a first sample volume, expelling the produced fluid from the first syringe pump to a collection flask while receiving the produced fluid with the second syringe pump, selectively receiving the produced fluid with the first syringe pump once the second syringe pump reaches a second sample volume, and expelling the produced fluid from the second syringe pump to the collection flask while receiving the produced fluid with the first syringe pump.

The method of paragraph [0076], further comprising repeating selectively receiving the produced fluid with a second syringe pump once the first syringe pump reaches a first sample volume, expelling the produced fluid from the first syringe pump to a collection flask while receiving the produced fluid with the second syringe pump, selectively receiving the produced fluid with the first syringe pump once the second syringe pump reaches a second sample volume, and expelling the produced fluid from the second syringe pump to the collection flask while receiving the produced fluid with the first syringe pump one or more times.

The method of paragraph [0076] or [0077] further comprising maintaining a selected pressure in the first syringe pump or the second syringe pump, as the case may be, while receiving the produced fluid.

The method of any one of paragraphs [0076] to [0078], wherein a produced volume of the produced fluid is held constant while there is a drop in a system pressure.

The method of any one of paragraphs [0076] to [0079], further comprising reducing the selected pressure to an expel pressure prior to expelling the produced fluid from the first syringe pump or the second syringe pump, as the case may be.

The method of paragraph [0080], wherein the expel pressure is substantially zero psig/kPag.

The method of any one of paragraphs [0076] to [0081], wherein the collection flask comprises a plurality of collection flasks, the method further comprising selectively expelling the produced fluid to one of the plurality of collection flasks.

The method of paragraph [0082], wherein, wherein the one of the plurality of collection flasks is incremented before each expelling.

The method of paragraph [0082] or [0083], wherein the produced fluid in each of the plurality of collection flasks is analyzed separately.

The method of any one of paragraphs [0076] to [0084], wherein the produced fluid is collected from a test chamber.

The method of any one of paragraphs [0076] to [0085], wherein the produced fluid comprises oil and water.

The method of any one of paragraphs [0076] to [0086], wherein the produced fluid comprises condensate substantially at its saturated liquid state.

The method of any one of paragraphs [0076] to [0087], wherein the produced fluid comprises multiphase fluid.

The method of paragraph [0088], wherein the multiphase fluid comprises water, gas, and oil.

The method of any one of paragraphs [0076] to [0089], further comprising analyzing the produced fluid to provide a produced fluid analysis.

The method of paragraphs [0090], wherein the produced fluid analysis comprises fractional flow data analysis.

A computer readable medium having thereon computer instruction code which may be interpreted by a computer to perform the method of any one of paragraphs [0076] to [0091].

A system for collecting a produced fluid comprising a first syringe pump, a second syringe pump, and a controller, adapted to selectively direct the produced fluid to the first syringe pump or the second syringe pump, the controller further adapted to selectively expel the produced fluid from the other of the first syringe pump and the second syringe pump.

The system of paragraph [0093], wherein the controller is adapted to selectively actuate one or more control means to selectively direct the produced fluid.

The system of paragraph [0094], wherein the one or more control means comprises one or more control valves.

The system of any one of paragraphs [0093] to [0095], wherein the controller is adapted to control a selected pressure in the first syringe pump or the second syringe pump, as the case may be, as the produced fluid is directed to the first syringe pump or the second syringe pump.

The system of any one of paragraphs [0093] to [0096], wherein a produced volume of the produced fluid is held constant while there is a drop in a system pressure.

The system of any one of paragraphs [0093] to [0097], wherein the controller is adapted to reduce the selected pressure to an expel pressure prior to expelling the produced fluid from the first syringe pump or the second syringe pump, as the case may be.

The system of paragraph [0098], wherein the expel pressure is substantially zero psig/kPag.

The system of any one of paragraphs [0093] to [0099], further comprising a multiport production system adapted to selectively direct the expelled produced fluid to one of a plurality of collection flasks.

The system of paragraph [00100], wherein the multiport production system comprises a multiport valve, having an inlet and a plurality of outlets, each configured to discharge to a corresponding one of the plurality of collection flasks.

The system of paragraph [00101], wherein the controller is adapted to selectively increment the multiport valve corresponding to the selectively expelling the produced fluid.

The embodiments described herein are intended to be examples only. Alterations, modifications and variations can be effected to the particular embodiments by those of skill in the art. The scope of the claims should not be limited by the particular embodiments set forth herein, but should be construed in a manner consistent with the specification as a whole.

What is claimed is:

1. A method collecting a produced fluid, comprising:
a. selectively receiving the produced fluid with a first syringe pump;
b. selectively receiving the produced fluid with a second syringe pump once the first syringe pump reaches a first sample volume;
c. expelling the produced fluid from the first syringe pump to a collection flask while receiving the produced fluid with the second syringe pump;
d. selectively receiving the produced fluid with the first syringe pump once the second syringe pump reaches a second sample volume; and
e. expelling the produced fluid from the second syringe pump to the collection flask while receiving the produced fluid with the first syringe pump.

2. The method of claim 1, further comprising repeating b. through e. one or more times.

3. The method of claim 1, further comprising maintaining a selected pressure in the first syringe pump or the second syringe pump, as the case may be, while receiving the produced fluid.

4. The method of claim 1, wherein a produced volume of the produced fluid is held constant while there is a drop in a system pressure.

5. The method of claim 4, further comprising reducing the selected pressure to an expel pressure prior to expelling the produced fluid from the first syringe pump or the second syringe pump, as the case may be.

6. The method of claim 5, wherein the expel pressure is substantially zero psig/kPag.

7. The method of claim 1, wherein the collection flask comprises a plurality of collection flasks, the method further comprising selectively expelling the produced fluid to one of the plurality of collection flasks.

8. The method of claim 7, wherein the one of the plurality of collection flasks is incremented before each expelling.

9. The method of claim 8, wherein the produced fluid in each of the plurality of collection flasks is analyzed separately.

10. The method of claim 8, wherein the produced fluid is collected from a test chamber.

11. The method of claim 8, wherein the produced fluid comprises oil and water.

12. The method of claim 8, wherein the produced fluid comprises condensate substantially at its saturated liquid state.

13. The method of claim 8, wherein the produced fluid comprises multiphase fluid.

14. The method of claim 13, wherein the multiphase fluid comprises water, gas, and oil.

15. The method of claim 8, further comprising analyzing the produced fluid to provide a produced fluid analysis.

16. The method of claim 15, wherein the produced fluid analysis comprises fractional flow data analysis.

17. A computer readable medium having thereon computer instruction code which may be interpreted by a computer to perform the method of any one of claims 1-16.

18. A system for collecting a produced fluid comprising:
a. a first syringe pump;
b. a second syringe pump; and
c. a controller, adapted to selectively direct the produced fluid to the first syringe pump or the second syringe pump, the controller further adapted to selectively expel the produced fluid from the other of the first syringe pump and the second syringe pump.

19. The system of claim 18, wherein the controller is adapted to selectively actuate one or more control means to selectively direct the produced fluid.

20. The system of claim 18, wherein the one or more control means comprises one or more control valves.

21. The system of claim 18, wherein the controller is adapted to control a selected pressure in the first syringe pump or the second syringe pump, as the case may be, as the produced fluid is directed to the first syringe pump or the second syringe pump.

22. The system of claim 18, wherein a produced volume of the produced fluid is held constant while there is a drop in a system pressure.

23. The system of claim 22, wherein the controller is adapted to reduce the selected pressure to an expel pressure prior to expelling the produced fluid from the first syringe pump or the second syringe pump, as the case may be.

24. The system of claim 23, wherein the expel pressure is substantially zero psig/kPag.

25. The system of claim 18, further comprising a multiport production system adapted to selectively direct the expelled produced fluid to one of a plurality of collection flasks.

26. The system of claim 18, wherein the multiport production system comprises a multiport valve, having an inlet and a plurality of outlets, each configured to discharge to a corresponding one of the plurality of collection flasks.

27. The system of claim 26, wherein the controller is adapted to selectively increment the multiport valve corresponding to the selectively expelling the produced fluid.
